(19) United States
(12) Patent Application Publication
(10) Pub. No.: US 2024/0430021 A1
(43) Pub. Date: Dec. 26, 2024

(54) NETWORK DEVICE AND DETERMINATION METHOD

(71) Applicant: Fujitsu Limited, Kawasaki-shi (JP)

(72) Inventor: Shunsuke FUJIO, Kawasaki-shi (JP)

(73) Assignee: Fujitsu Limited, Kawasaki-shi (JP)

(21) Appl. No.: 18/679,688

(22) Filed: May 31, 2024

(30) Foreign Application Priority Data
Jun. 26, 2023 (JP) 2023-104368

(51) Int. Cl. H04B 17/318

(52) U.S. Cl. CPC H04B 17/318

(57) ABSTRACT

A first communication device includes, a measurer that receives signals transmitted from a second communication device by using beams in different directions in the first communication device as a plurality of signals, and measures received power for each of the received beams, and a determinator that calculates a ratio of received power of a central-direction beam including a direction from the first communication device to the second communication device to a total of received power of the plurality of the beams, and determines a visibility state between the first communication device and the second communication device in accordance with the ratio.

### CROSS-REFERENCE TO RELATED APPLICATION

This application is based upon and claims the benefit of priority of the prior Japanese Patent Application No. 2023-104368, filed on Jun. 26, 2023, the entire contents of which are incorporated herein by reference.

### FIELD

The present disclosure relates to a network device and a determination method.

### BACKGROUND

In recent years, in accordance with implementation of a large capacity of transmission data, communication using millimeter waves has attracted attention. Although millimeter wave communication enables large-capacity communication using a broad band, it has characteristics that cause a propagation loss and a loss according to shielding to become large. Thus, in order to improve communication quality, a mobile relay communication system in which a relay communication terminal (relay station (RS)) is mounted in a mobile device such as an unmanned aerial vehicle (UAV), and the RS is moved to an appropriate place has been reviewed. In the mobile relay communication system, the RS forms a beam and performs radio communication with a terminal device.

In a mobile relay communication system, in order to determine a movement destination of an RS, for example, there are cases in which a state of a propagation path of a movement destination is determined (predicted). As a determined state of a propagation path, for example, there is a state of visibility. The state of visibility represents presence/absence of a shielding object that shields propagation along a propagation path, an environment in which no shielding object is present is referred to as a visibility inside environment (line of sight (LOS)), and an environment in which a shielding object is present is referred to as a visibility outside environment (non-LOS (NLOS)). As a movement destination of the RS, for example, a visibility inside environment (LOS) is preferable.

Methods for determining a state of visibility, for example, are described in the following literature.

### CITATION LIST

### Patent Literature

Patent Literature 1: Japanese Translation of PCT Application No. 2009-545934
Patent Literature 2: Japanese Patent Application Publication No. 2010-187359
Patent Literature 3: WO 2020/202401
Patent Literature 4: Japanese Patent Application Publication No. 2022-162583

### SUMMARY

A first communication device includes, a measurer that receives signals transmitted from a second communication device by using beams in different directions in the first communication device as a plurality of signals, and measures received power for each of the received beams, and a determinator that calculates a ratio of received power of a central-direction beam including a direction from the first communication device to the second communication device to a total of received power of the plurality of the beams, and determines a visibility state between the first communication device and the second communication device in accordance with the ratio.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram illustrating a configuration example of a radio communication system 10.

FIG. 2 is a diagram illustrating a configuration example of the relay communication device 200.

FIG. 3 is a diagram illustrating an example of graphs representing relations between a distance and received power in an LOS/NLOS.

FIGS. 4A and 4B are diagrams illustrating an example in which a signal in the LOS/NLOS is received using beams in a plurality of directions.

FIG. 5 is a diagram illustrating an example of signals of measurement targets in the multiple-direction beam measuring process.

FIG. 6 is a diagram illustrating an example of a processing flowchart of the visibility state determining process S100.

FIG. 7 is a diagram illustrating an example of Equation 1 with a relation between an inter-transmission/reception distance and received power taken into account.

FIG. 8 is a diagram illustrating an example of Equation 5 calculating of the parameters.

### DESCRIPTION OF EMBODIMENTS

For example, in a system estimating a state of visibility from a relation between received power of radio waves and a distance, when variations of received power become large in accordance with the influence of shadowing and the like, the determination accuracy of the state of visibility becomes low. When the NLOS or the LOS is determined incorrectly due to a decrease in the accuracy of determination of the state of visibility, an appropriate movement destination of an RS cannot be determined, and no improvement of communication quality may be achieved. One disclosure can improve prediction accuracy of the state of visibility.

### First Embodiment

A first embodiment will be described.

### Radio Communication System 10

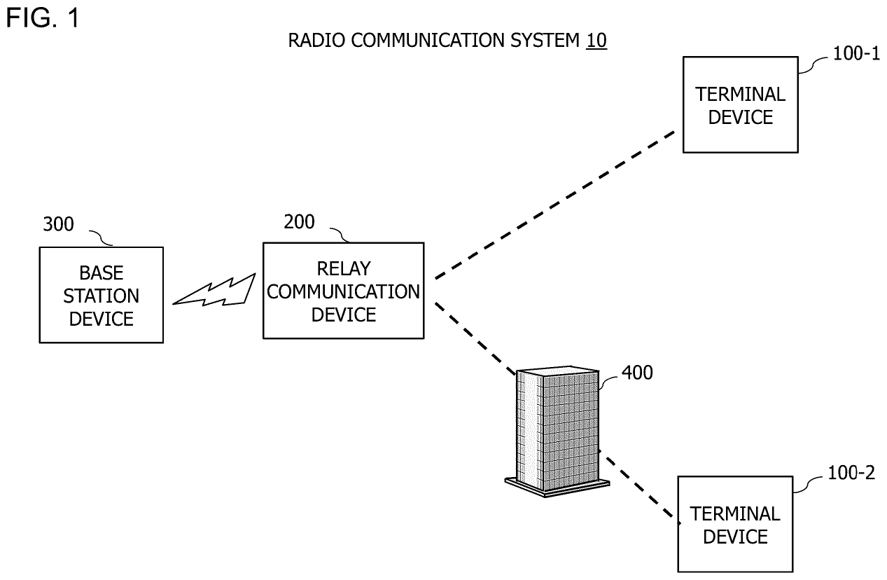

FIG. 1 is a diagram illustrating a configuration example of a radio communication system 10. The radio communication system 10 includes a base station device 300, a relay communication device 200, and terminal devices 100-1 and 100-2. The radio communication system 10 is a mobile relay communication system that performs radio communication with the terminal devices 100-1 and 100-2 by moving (disposing) the relay communication device 200 to an appropriate position.

The base station device 300 is a device that performs radio communication with the terminal devices 100-1 and 100-2 (which may hereinafter be referred to as a terminal device 100) through the relay communication device 200 and, for example, is an eNodeB or a gNodeB. In addition, the base station device 300 may be configured as a one unit or may be configured as a plurality of units such as a central unit (CU), a distributed unit (DU), and the like. Furthermore, the base station device 300 may perform radio communication using wireless connection with the terminal device 100 rather than through the relay communication device 200.

The relay communication device 200 is a device that relays communication between the terminal device 100 and the base station device 300 and, for example, is an RS. In addition, the relay communication device 200 is a network device that configures a network of radio communication with the terminal device 100, the base station device 300, and the like. For enabling movement to an appropriate position, the relay communication device 200, for example, is mounted in a UAV such as a drone. The relay communication device 200 is wirelessly connected to the base station device 300 and the terminal device 100 and performs radio communication. The relay communication device 200 measures a signal transmitted from the terminal device 100 using beams in a plurality of directions and executes a state-of-visibility determining process of determining a state of visibility for the terminal device 100. The reason for performing measurement using beams in the plurality of directions is that a signal transmitted by the terminal device 100 reaches the relay communication device 200 from a plurality of directions in accordance with diffusion, reflection, and the like. Hereinafter, measurement of a signal transmitted from the terminal device 100 using beams in a plurality of directions may be referred to as multiple-direction beam measurement.

The terminal device 100 is a communication device that is wirelessly connected to the base station device 300 and the relay communication device 200 and performs radio communication and, for example, is a radio communication device such as a smartphone or a tablet terminal.

The relay communication device 200, for example, determines a state of visibility for the terminal device 100-1. The state of visibility between the relay communication device 200 and the terminal device 100-1 is an LOS due to absence of a shielding object 400. The relay communication device 200 performs multiple-direction beam measurement of the terminal device 100-1 and determines the state of visibility.

On the other hand, the relay communication device 200, for example, determines a state of visibility for the terminal device 100-2. The state of visibility between the relay communication device 200 and the terminal device 100-2 is an NLOS due to presence of a shielding object 400. The relay communication device 200 performs multiple-direction beam measurement of the terminal device 100-2 and determines the state of visibility to be the NLOS.

### Configuration Example of Relay Communication Device 200

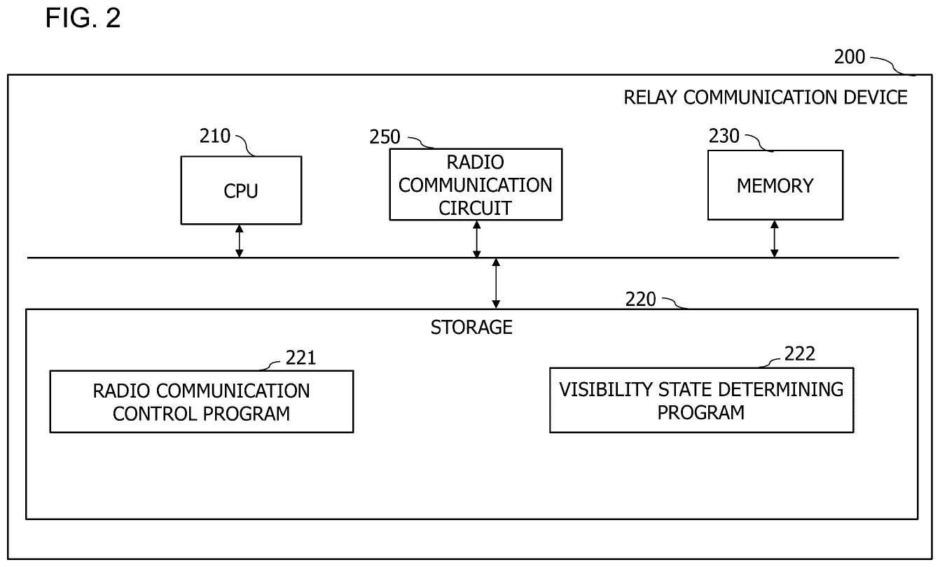

FIG. 2 is a diagram illustrating a configuration example of the relay communication device 200. The relay communication device 200 has a central processing unit (CPU) 210, a storage 220, a memory 230, and a radio communication circuit 250.

The storage 220 is an auxiliary storage device such as a flash memory, a hard disk drive (HDD), or a solid state drive (SSD) that stores programs and data. The storage 220 stores a radio communication control program 221 and a visibility state determining program 222.

The memory 230 is an area in which a program stored in the storage 220 is loaded. In addition, the memory 230 may also be used as an area in which a program stores data.

The radio communication circuit 250 is a device that performs radio communication with the terminal device 100 and the base station device 300. The relay communication device 200 forms a beam and transmits/receives signals (messages) to/from the terminal device 100 and the base station device 300 through the radio communication circuit 250.

The CPU 210 is a processor that loads a program stored in the storage 220 into the memory 230, executes the loaded program, constructs each unit, and realizes each process.

The CPU 210 executes the radio communication control program 221, thereby performing a radio communication control process. The radio communication control process is a process of performing wireless connection with the terminal device 100 and the base station device 300 and relaying radio communication of the terminal device 100. In the radio communication control process, the relay communication device 200 transmits a signal received from the terminal device 100 to the base station device 300 and transmits a signal, which has been received from the base station device 300, addressed to the terminal device 100 to the terminal device 100.

By executing the visibility state determining program 222, the CPU 210 constructs a measurement unit and a determination unit and performs the visibility state determining process. The visibility state determining process is a process of determining the state of visibility for the terminal device 100. In the visibility state determining process, the relay communication device 200 performs multiple-direction beam measurement and determines a state of visibility for this terminal device 100.

### Determination Accuracy of Visibility State

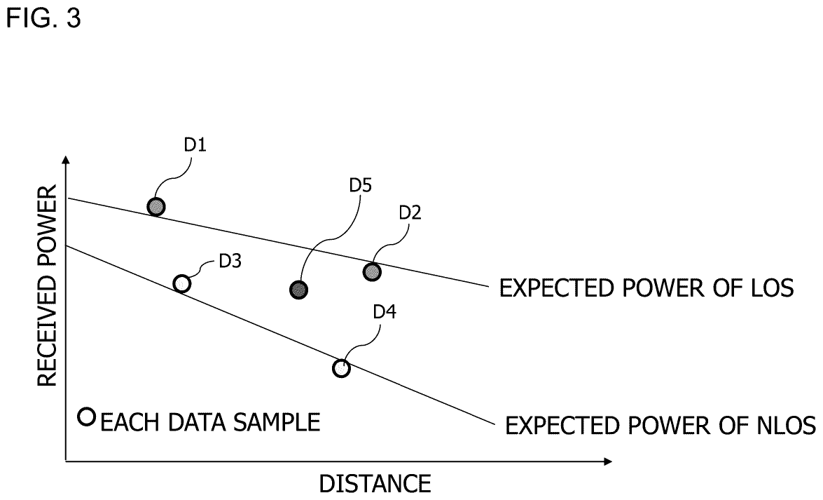

The determination accuracy of the visibility state will be described. FIG. 3 is a diagram illustrating an example of graphs representing relations between a distance and received power in an LOS/NLOS. In the graphs illustrated in FIG. 3, the received power is represented on a vertical axis, and the distance is represented on a horizontal axis. The distance, for example, is a distance between the terminal device 100 and the relay communication device 200. In addition, the graphs illustrated in FIG. 3 represent expected power of the case of the LOS and expected power of the case of the NLOS.

For example, it can be understood that sample data D1 and D2 are positioned within a predetermined range near the graph of the expected power of the LOS and are data of received power of the LOS. In addition, for example, it can be understood that samples D3 and D4 are positioned within a predetermined range near the graph of the expected power of the NLOS and thus are data of received power of the NLOS.

However, for example, data of sample data D5 is positioned near the middle of the graph of the expected power of the LOS and the graph of the expected power of the NLOS, and thus it is difficult to determine whether the measurement environment is the LOS or the NLOS.

In this way, it is difficult to determine the visibility state only from a relation between the received power and the distance in accordance with data, and there are cases in which the accuracy of the determination is degraded.

### Characteristic of Received Power According to Visibility State

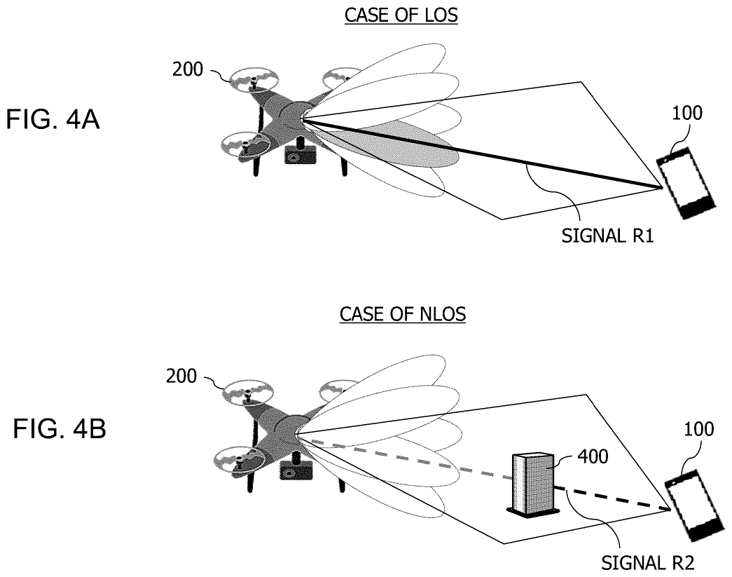

A difference in the received power according to a visibility state will be described. FIGS. 4A and 4B are diagrams illustrating an example in which a signal in the LOS/NLOS is received using beams in a plurality of directions. A direction to be described below represents a relative direction with respect to a forward direction of an antenna included in the relay communication device 200.

FIG. 4A is a diagram illustrating an example of a signal in the LOS. Among signals transmitted from the terminal device 100, a signal propagating through a path in a direction of the relay communication device 200 (which may hereinafter be referred to as a central direction) will be referred to as a signal (reference signal) R1. Aside from the signal R1 propagating through the path in the central direction, there are a signal R2 and a signal R3 as signals reaching the relay communication device 200 through paths different from that of the signal R1 in accordance with reflection or the like. At this time, although the signal R1 in the central direction attenuates in accordance with a distance, compared to the signals R2 and R3 reaching in accordance with diffusion or reflection, it has quite high received power. At this time, each signal is assumed to be received by using a beam in a direction matching the angle of the signal reaching the relay communication device 200. Received power according to a beam in a direction matching the angle of a signal in the central direction is referred to as received power of the beam in the central direction. In addition, received power according to beams in directions matching angles of the signal R2 and the signal R3 will be referred to as received power of the beam R2 and received power of the beam R3. Hereinafter, the received power of the beam R2 and the received power of the beam R3 may be referred to as received power of beams in other directions. FIG. 4B is a diagram illustrating an example of signals of the NLOS. Among signals transmitted from the terminal device 100, a signal propagating through a path in the central direction will be referred to as a signal R4. Aside from the signal R4 propagating through the path in the central direction, there are a signal R5 and a signal R6 as signals reaching the relay communication device 200 through paths different from that of the signal R4 in accordance with reflection or the like. At this time, in addition to attenuation according to a distance, the signal R4 in the central direction also attenuates in accordance with collision with a shielding object 400. For this reason, the received power of the signal R4 becomes smaller than that of the signal R1 in the central direction in the LOS illustrated in FIG. 4A by an amount corresponding to attenuation according to the shielding object 400. On the other hand, in the case of no collision with the shielding object 400, the signals R5 and R6 have received power of the same levels as the signals R2 and R3 illustrated in FIG. 4A. In addition, each signal is assumed to be received using a beam in a direction matching the angle of the signal reaching the relay communication device 200. The received power according to a beam in a direction matching the angle of the signal in the central direction will be referred to as received power of the beam in the central direction. The received power according to beams in directions matching the angles of the signal R5 and the signal R6 will be respectively referred to as received power of the beam R5 and received power of the beam R6. Hereinafter, the received power of the beam R5 and the received power of the beam R6 may be referred to as received power of beams in other directions.

In this way, the received power of the beam in the central direction in the NLOS becomes smaller than the received power of the beam in the central direction in the LOS. On the other hand, the received power of the beams in the other directions does not change much between the NLOS and the LOS. In other words, it can be assumed that a ratio of the received power of the beam in the central direction to the received power of the beams in the other directions in the NLOS becomes lower than a ratio of the received power of the beam in the central direction to the received power of the beams in the other directions in the LOS.

Thus, in the visibility state determining process according to the first embodiment, by using this assumption, a ratio of the received power of the beam in the central direction to a total value of received power of beams in predetermined directions is calculated, and a visibility state (the state of one of the LOS or the NLOS) is determined using the calculated ratio.

### Multiple-Direction Beam Measuring Process

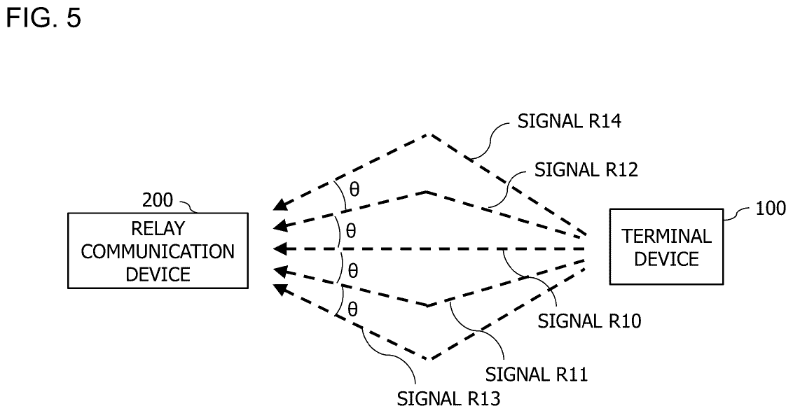

A multiple-direction beam measuring process will be described. FIG. 5 is a diagram illustrating an example of signals of measurement targets in the multiple-direction beam measuring process. FIG. 5, for example, is a diagram of the relay communication device 200 and the terminal device 100 seen from above. In addition, for example, measuring of beams in a plurality of directions can be rephrased as receiving and measuring of signals using a plurality of antennas directed in different directions. Alternatively, measuring of beams in a plurality of directions can be rephrased as receiving and measuring of signals of a plurality of directions by electrically controlling a plurality of antennas to have directivity of beams.

The relay communication device 200 sets a signal R10 in the central direction as a measurement target of the received power. Signals shifted from the center direction by each predetermined angle (θ) are also set as measurement targets. For example, in FIG. 5, the signal R10 in the central direction and signals R11 and R12 shifted by a predetermined angle θ in a horizontal direction are measurement targets. In addition, signals R13 and R14 further being shifted respectively from the signals R11 and R12 by the predetermined angle θ in the horizontal direction are measurement targets as well. Each signal is assumed to be received using a beam in a direction matching the angle of a signal reaching the relay communication device 200. Received power using a beam in a direction matching the angle of a signal in the central direction will be referred to as received power of the beam in the central direction. Received power using beams in directions matching the angles of signals R11, R12, R13, and R14 will be respectively referred to as received power of a beam R11, received power of a beam R12, received power of a beam R13, and received power of a beam R14. Hereinafter, the received power of the beam R11, the received power of the beam R12, the received power of a beam R13, and received power of a beam R14 may be referred to as received power of beams in other directions. In addition, a beam in a direction matching the angle of a signal that is a measurement target will be referred to as a beam that is a measurement target or a beam of a measurement target.

The number of beams that are measurement targets and the predetermined angle θ, for example, are determined in accordance with reception sensitivity and performance of an antenna, measurement environments (for example, including presence/absence of a reflective object, a temperature, a humidity, and the like), a processing capability of a processor included in the relay communication device 200, and the like.

In addition, FIG. 5 is an example in which the predetermined angle θ is in the horizontal direction, and vertical directions of all the beams are the same. However, for beams of measurement targets, for example, the predetermined number may be determined by shifting the beams also in the horizontal direction and the vertical direction with shifting directions set as the horizontal direction a and the vertical direction β.

In addition, in FIG. 5, although beams of measurement targets are determined by shifting the beams by each predetermined angle θ, shifting angles are allowed not to be constantly the same. The shifting angle, for example, may be configured to be smaller as it further approaches the central direction. In addition, the shifting angle may be determined on the basis of measurement data of the past.

### Visibility State Determining Process

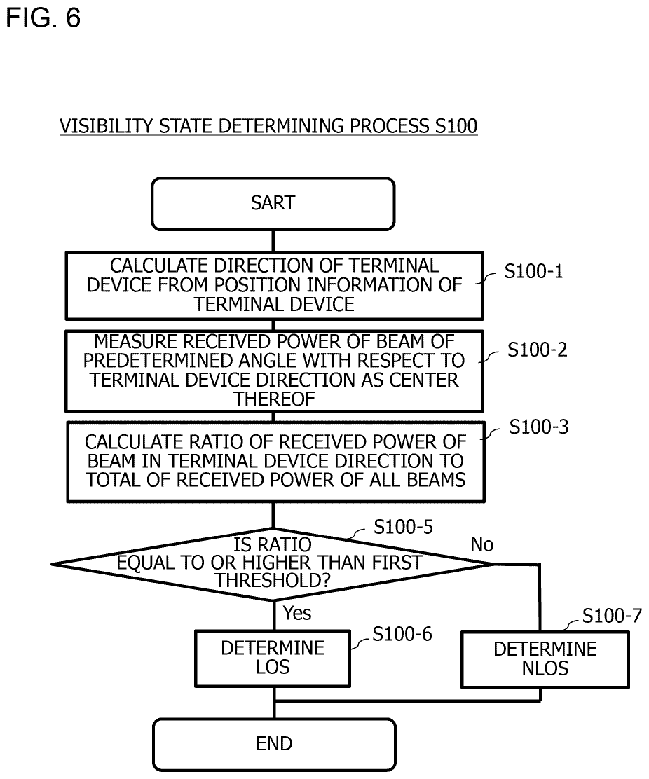

A visibility state determining process S100 will be described. FIG. 6 is a diagram illustrating an example of a processing flowchart of the visibility state determining process S100. The relay communication device 200 executes the visibility state determining process S100 at a predetermined timing.

In the visibility state determining process S100, the relay communication device 200 calculates a direction of the terminal device 100 (a central direction) from position information of the terminal device 100 (S100-1).

The relay communication device 200 measures received power of beams of predetermined angles with respect to the direction of the terminal device 100 as its center (Step S100-2). For example, as illustrated in FIG. 5, the relay communication device 200 measures a beam R10 in the central direction and beams R11 to R14 of other four directions.

The relay communication device 200 calculates a ratio of received power of a beam in the direction of the terminal device 100 (the central direction) to a total of received power of all the beams (S100-3). For example, in a case in which measurement of beams illustrated in FIG. 5 is performed, the relay communication device 200 calculates a ratio of received power of the beam R10 to a total value of received power of the beams R10 to R14.

The relay communication device 200 compares the calculated ratio with a first threshold (S100-5). The first threshold is a threshold used for determining whether the state is the LOS or not. For example, in a case in which the ratio is larger (or equal to or more) than the first threshold, the relay communication device 200 determines the LOS.

The first threshold, for example, is determined from measurement data of the past or the like and is stored in a memory or the like of the relay communication device 200 in advance. For example, the smaller the number of beams to be measured, the smaller a total value of received power of all the beams, and thus the ratio of the received power of the beam in the central direction becomes large. From this assumption, the smaller the number of beams to be measured, a larger value is set to the first threshold.

In addition, for example, the larger the width of a beam to be measured, the more multi-path components included in the beam in the central direction, and thus, the ratio of the received power of the beam in the central direction becomes high. From this assumption, the larger the width of a beam to be measured, a larger value is set to the first threshold.

In a case in which the ratio is the first threshold or more (Yes in S100-5), the relay communication device 200 determines the LOS (S100-6) and ends the process.

On the other hand, in a case in which the ratio is not the first threshold or more (No in S100-5), the relay communication device 200 determines the NLOS (S100-7) and ends the process.

In the first embodiment, by determining the LOS or the NLOS from the ratio of the received power of the beam in the central direction, even in a case in which a variation occurs in the entire received power, degradation of determination accuracy can be prevented.

### Second Embodiment

A second embodiment will be described. In the second embodiment, a relay communication device 200 determines a visibility state with a relation between an inter-transmission/reception distance and received power (for example, the graphs illustrated in FIG. 3 and the like) also taken into account.

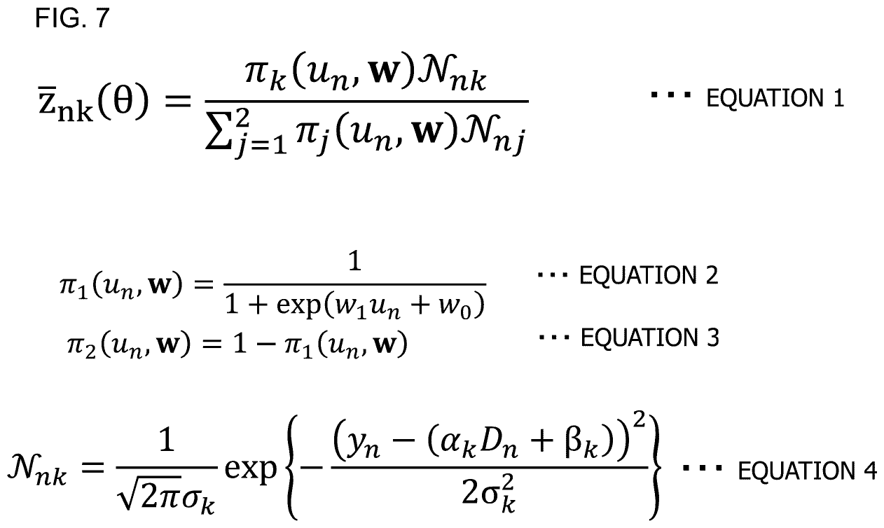

FIG. 7 is a diagram illustrating an example of Equation 1 with a relation between an inter-transmission/reception distance and received power taken into account.

In Equation 1, zₙₖ(θ) represent a probability of a data sample n being the LOS (or the NLOS). Here, k=1 represents the LOS, and k=2 represents the NLOS. The relay communication device 200 determines k for which zₙₖ(θ) becomes a maximum to be a visibility state of the data sample n.

πₖ(uₙ, w) represents a probability of the LOS (or the NLOS) corresponding to a beam power ratio uₙ. A case of k=1 is represented using Equation 2, and a case of k=2 is represented using Equation 3.

uₙ represents a ratio of received power of a beam in a central direction of the data sample n. w is a parameter and is represented as w=[w1, w0]. w1 is a weight parameter for the ratio, and w0 is a bias parameter for a beam power ratio.

Nₙₖ represents a probability of acquiring received power of a data sample n in the case of the LOS (or the NLOS) and is represented using Equation 4. Dₙ represents an inter-transmission/reception distance (logarithm) of a data sample n. yₙ represents received power (logarithm) of a data sample n. For example, Nₙ₁ represents a probability of acquiring received power yₙ in the case of the LOS.

θ represents a parameter set (α1, β1, σ1, α2, β2, σ2, w0, and w1).

αk is a distance attenuation parameter of received power. βk is an offset parameter of received power. σk is a standard deviation parameter of variations of received power. The parameter set θ, for example, is calculated using measured values and the like of the past and is set in the relay communication device 200 in advance.

In the second embodiment, determination of a visibility state with a relation between a distance and received power also taken into account can be performed.

### Third Embodiment

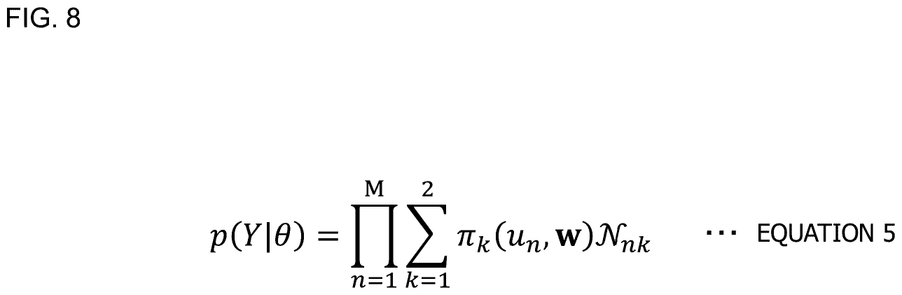

A third embodiment will be described. In the third embodiment, by performing central management of data acquired at various positions and using the data, setting of parameters in advance is not performed. A relay communication device 200 determines the parameters on the basis of acquired data such that the likelihood of Equation 5 represented in FIG. 8 becomes a maximum. M represents the number of data samples.

In Equation 5, processes after calculation of the parameters are similar to those according to the second embodiment.

### Other Embodiments

The visibility state determining process S100, for example, may be executed by a base station device 300 or a control device (not illustrated) connected to the base station device 300. In a case in which the visibility state determining process S100 is executed by the base station device 300 or the control device, a relay communication device 200 transmits a measurement result to the device executing the visibility state determining process. In addition, the relay communication device 200 executes a multiple-direction beam measuring process in accordance with (in response to) an instruction from the control device or the base station device 300. In addition, the control device, for example, is a device that controls the base station device 300 and is a network device.

In addition, the visibility state determining process S100, for example, may be executed by a terminal device 100. In a case in which the visibility state determining process is executed by the terminal device 100, the terminal device 100 measures a signal transmitted from the relay communication device 200 using beams in multiple directions and determines a visibility state.

In addition, the determination result of the visibility state, for example, is transmitted to the control device or the base station device 300 and is used for determining a movement destination in the relay communication device 200 of a radio communication system 10.

Hereinafter, by summarizing these, the following supplementary notes are formed.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosure have been described in detail, it should be understood that the various changes, substitutions, and alterations could be made hereto without departing from the spirit and scope of the disclosure.

What is claimed is:

1. A first communication device comprising:
a measurer that receives signals transmitted from a second communication device by using beams in different directions in the first communication device as a plurality of signals, and measures received power for each of the received beams; and
a determinator that calculates a ratio of received power of a central-direction beam including a direction from the first communication device to the second communication device to a total of received power of the plurality of the beams, and determines a visibility state between the first communication device and the second communication device in accordance with the ratio.

2. A network device comprising:
a measurement controller that causes beams in a plurality of directions to receive signals transmitted from a second communication device to a first communication device, and causes each of the beams in the plurality of directions to measure received power; and
a determinator that calculates a ratio of received power of a central-direction beam including a direction from the first communication device to the second communication device to a total of received power of the beams in the plurality of directions, and determines a visibility state between the first communication device and the second communication device in accordance with the ratio.

3. The network device according to claim 2, wherein, when the ratio is higher than a first threshold, the determinator determines the visibility state to be a line of sight.

4. The network device according to claim 3, wherein, the smaller the number of beams to be measured by the first communication device, a larger value is set to the first threshold.

5. The network device according to claim 3, wherein, the larger a beam width of each of the beams, a larger value is set to the first threshold.

6. The network device according to claim 2, wherein the determinator calculates an inter-device distance between the first communication device and the second communication device, and determines the visibility state in accordance with the ratio and the inter-device distance.

7. A determination method comprising:
receiving signals transmitted from a second communication device to a first communication device by using beams in different directions in the first communication device as a plurality of signals, and measuring received power for each of the received beams; and
calculating a ratio of received power of a central-direction beam including a direction from the second communication device to the first communication device to a total of received power of the plurality of the beams, and determining a visibility state between the first communication device and the second communication device in accordance with the ratio.

8. The first communication device according to claim 1, wherein the first communication device is a relay communication device that relays radio communication between a base station device and the second communication device.
